(19) United States
(12) Patent Application Publication
(10) Pub. No.: US 2005/0151937 A1
(43) Pub. Date: Jul. 14, 2005

(54) Light source apparatus

(75) Inventor: Akihiko Sugitani, Hyogo (JP)

Correspondence Address: RADER FISHMAN & GRAUER PLLC, LION BUILDING, 1233 20TH STREET N.W., SUITE 501, WASHINGTON, DC, 20036, US

(73) Assignee: USHIO DENKI KABUSHIKI KAISHA

(21) Appl. No.: 11/024,768

(22) Filed: Dec. 30, 2004

(30) Foreign Application Priority Data
Jan. 9, 2004 (JP) 2004-003765

(51) Int. Cl. G03B 21/20

(52) U.S. Cl. 353/85

(57) ABSTRACT

It is an object of the present invention to provide a light source apparatus having a rotation filter, in which brightness of an image and/or color reproducibility of RGB is improved, and miniaturization and simplification is attained. A light source apparatus comprising a rotation filter having a light condensing area, in which at least a first color area and a second color area are formed, a lens to which light passing through the light condensing area is incident, an image display device receiving light emitted from the rod integrator lens, a discharge lamp; and a power supply controlling apparatus which controls power supply to the discharge lamp, wherein the power supply controlling apparatus shuts off or reduces current applied to the discharge lamp when a boundary between the first color area and the second color area is located at a position corresponding to the light condensing area.

### TECHNICAL FIELD OF THE INVENTION

The present invention relates to a light source apparatus used for a single panel type projector apparatus using a rotation filter, and especially to a light source apparatus having a device which controls electric power supply, synchronizing with the rotation filter.

### DESCRIPTION OF RELATED ART

A projector apparatus using a liquid crystal device or DMD (Digital Micromirror Device) condenses light emitted from a light source (discharge lamp) and irradiates it on small elements which display image information, using a reflection mirror or a lens system, and make the reflected light or the transmitted light from the small elements irradiate to a screen through an optical system such as a lens. A The small element is less than one inch in length and when an angle component of incoming beam is small, the efficiency of light usage becomes high and the contrast of an image is also improved.

There are a single chip system and a three-plate system as a method for projecting color image information.

In such a three chip system, after radiation light from a light source is split into three colors (RGB), in each display element, light corresponding to image information is penetrated or reflected, and the three colors which have penetrated each display element are synthesized so as to project them on a screen after that.

On the other hand, in the single chip system, radiation light emitted from a light source is irradiated to a DMD through a rotation filter in which RGB areas are formed, and specific light is reflected by the DMD so as to emit it on a screen. The DMD has the structure in which millions of small mirrors are laid for every pixel, and projection of light is controlled by controlling the direction of each small mirror.

In the case of such a DMD system, one color image out of the RGB is projected on a screen for every short time, but since the time is extremely short so that, for human eyes, a color image synthesized is visually displayed on the screen. Since, as compared with a crystal liquid system, the optical system of the DMD system has a simple structure and it is not necessary to use three liquid crystal panels, there is an advantage of miniaturization and simplification of the body of the apparatus. However, in such a DMD system, in order to display one specific color (for example, R) for the time, light corresponding to other colors (for example, G, and B) are thrown away so that there is a problem that the overall usability of light is low. As a result, there is a problem that the screen brightness to an input electric power of a discharge lamp which is the light source is low.

In order to solve the above-mentioned problem, there is technology in which a W (white) area in addition to three colors (RGB) areas is formed in a rotation filter. This technology is to improve visibility, in which a bright image is given to human's vision as a whole by improving brightness of the whole screen, when light passes through (is condensed to) the W area. However, in case that the W area is provided in the rotation filter, the RGB areas on the filter not only become narrow but the reproducibility of other colors is also deteriorated since the influence of the white light is too strong on the boundary of the W area and the other color areas. That is, although the method using a rotation filter having a white area is effective in terms of the brightness of an image, there is a problem that the color reproducibility of RGB is deteriorated. Refer to Japanese Laid Open Patent No. 7-318939.

### SUMMARY OF THE INVENTION

It is an object of the present invention to provide a light source apparatus having a rotation filter, in which brightness of an image and/or color reproducibility of RGB is improved, and miniaturization and simplification is attained.

It is another object of the present invention to provide a light source for a projector having a rotation filter, in which brightness of an image and/or color reproducibility of RGB is improved, and miniaturization and simplification is attained.

The object of the present invention is attained by a light source apparatus comprising a rotation filter having a light condensing area, in which at least a first color area and a second color area are formed, a lens to which light passing through the light condensing area is incident, an image display device receiving light emitted from the rod integrator lens, a discharge lamp, a power supply controlling apparatus which controls power supply to the discharge lamp, wherein the power supply controlling apparatus shuts off or reduces current applied to the discharge lamp when a boundary between the first color area and the second color area is located at a position corresponding to the light condensing area.

Time for shutting off or reducing current applied to the discharge lamp may be 4 milliseconds or less.

In the discharge lamp, 0.16 mg/mm³ of mercury may be filled.

Further, the object of the present invention is attained by a light source apparatus comprising a rotation filter having a light condensing area, in which at least a first color area and a second color area are formed, a lens to which light passing through the light condensing area is incident, an image display device receiving light emitted from the rod integrator lens, a discharge lamp, and a power supply controlling apparatus which controls power supply to the discharge lamp, wherein the power supply controlling apparatus shuts off or reduces current applied to the discharge lamp when a boundary between the first color area and the second color area is located at a position corresponding to the light condensing area.

In the light source apparatus for a projector apparatus using a rotation filter, it is possible to attain all of the improvement in brightness of an image, the color-reproducibility of RGB, miniaturization, and simplification.

### DESCRIPTION OF THE DRAWINGS

The present inventions will now be described by way of example with reference to the following Figures, in which:

FIG. 1 is a schematic view of a light source apparatus according to the present invention; FIG. 2A shows an enlarged view of a rotation filter, wherein blue light is incident to the rod integrator;

FIG. 2B shows an enlarged view of a rotation filter, wherein a boundary of blue and white areas is located above the rod integrator so that blue light and white light are mixed and incident to the rod integrator;

FIG. 3A shows a signal which is sent to the power supply controlling apparatus 30 from the filter driving mechanism 210;

FIG. 3B is a graph of current value IL flowing through the discharge lamp;

FIG. 3C shows light output and color information projected on a screen, wherein the vertical axis represents light output and the horizontal axis shows time;

FIG. 4 is an over view of a high pressure discharge lamp which is used for a light source apparatus according to the present invention;

FIG. 5 shows a power supply feeding apparatus for lighting the discharge lamp 10;

FIG. 6 is the structure of the rotation filter according to an embodiment of the present invention; and

FIG. 7 shows relationship between light output and lamp current when the filter shown in FIG. 6 is used.

### DETAILED DESCRIPTION OF THE INVENTION

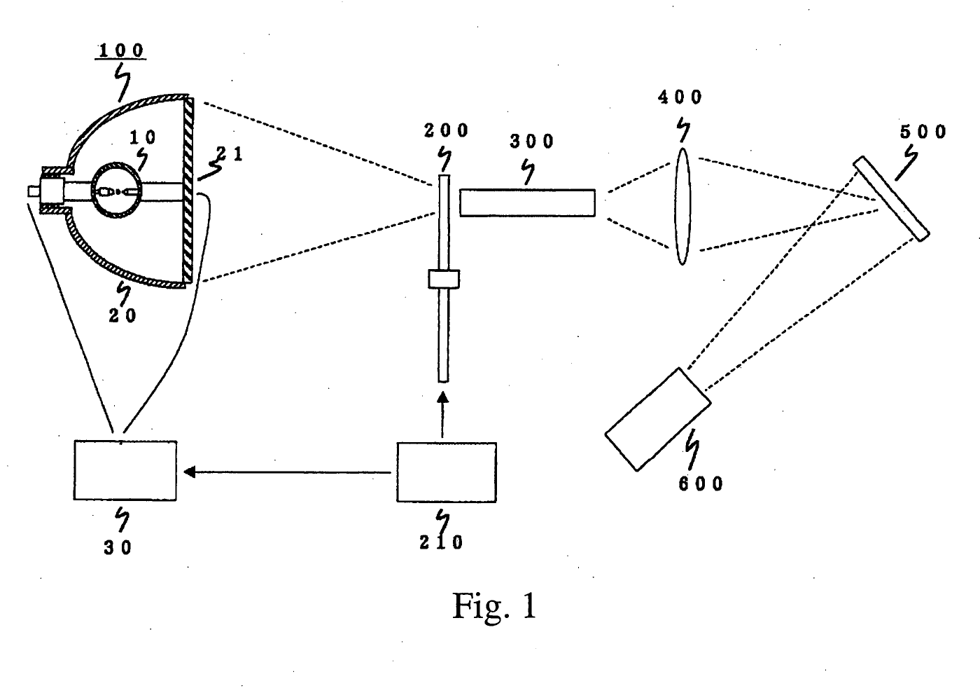

FIG. 1 is a schematic view of a light source apparatus according to the present invention.

The light source apparatus 100 comprises a discharge lamp 10 and a concave reflection mirror 20. In front of a light source apparatus 100, a rotation filter 200, a rod integrator lens 300, a lens 400, a DMD 500, and a lens 600 are arranged one by one.

The arc luminescent spot of the discharge lamp 10 and the first focal point of the concave reflection mirror 20 are arranged so as to locate at approximately the same position. The second focal point of the concave reflection mirror 20 is located approximately in the incidence edge of the rod integrator lens 300, and incidence of the reflected light from the concave reflection mirror 20 is carried out to the rod integrator lens 300 through the rotation filter 200. Driving control, for example, for rotating and stopping the filter 200 is carried out by a filter driving mechanism 210. Power supply control of the discharge lamp 10 is carried out by a power supply controlling apparatus 30. The discharge lamp 10 is turned on at, for example, rated power 200 W, rated current 2.6 A.

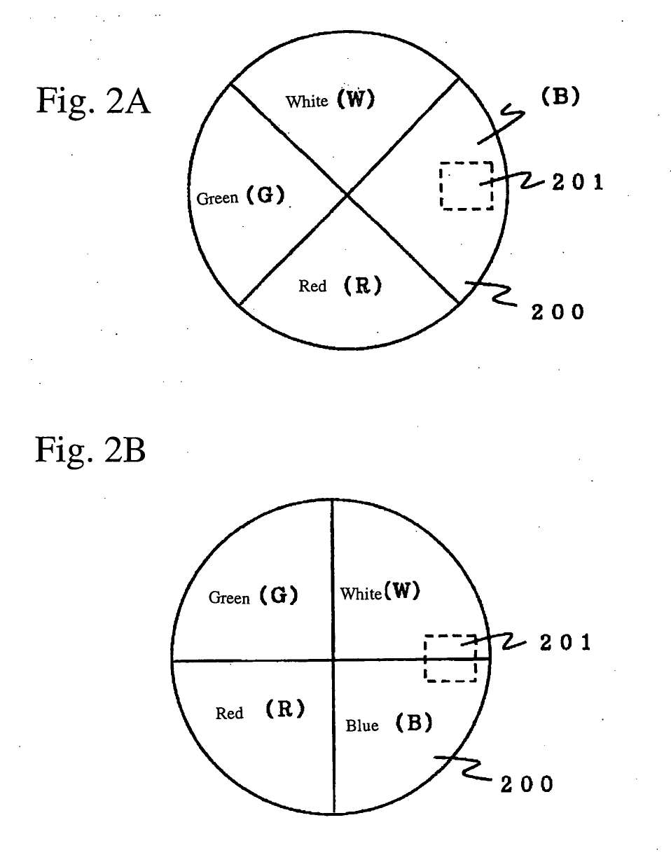

FIGS. 2A and 2B are an enlarged view of the rotation filter 200.

FIG. 2A shows a state where blue light is incident to the rod integrator. FIG. 2B shows a state where a boundary of blue and white areas is located above the rod integrator so that blue light and white light are mixed and incident to the rod integrator.

The rotation filter is called a color wheel and made from disc shaped glass.

In the filter, red (R), green (G), blue (B), and white (W) areas, each of which has a lemon wedge shape, are formed. Light reflected from the light source apparatus 100 transmits a light condensing area 201 formed on the rotation filter 200.

By rotation of the filter 200, color corresponding to the light condensing area 201 is led to the rod lens provided downstream one by one. Therefore, since red light (R), Green light (G), or blue light (B) is projected in a time-shared manner, only one of the colors is projected instantaneously through an image display element, human eyes visually recognize these colors or mixed colors as an image. Since white (W) light makes an image bright entirely, the image can be made brighter entirely by projecting white light at predetermined time intervals. Since the filter 200 is rotated at, for example, 180 Hz (180 revolutions per second), each of red, green, blue and white light is projected 180 times per second. Although each of the areas of filter 200 is determined by considering color balance and brightness of the ultimate image, the area of each color is shown as the same, as a matter of explanatory convenience in the drawings. The rotation filter 200 has, for example, a 25 mm diameter, and the light condensing area 201 has, for example, a 3.6×4.8 rectangular shape.

In the present invention, power supply to the discharge lamp is shut off or reduced when the rotation filter 200 is in a position where a boundary of one color area and another color area is located above the light condensing area (predetermined position), as shown in FIG. 2B. This is because it may not be used as color information by projection since in that state, 2 colors are mixed. In addition, in case that light emission of the discharge lamp is shut off or current applied to the discharge lamp is reduced, the current saved by stopping light emission or reducing current can be used at time of projection of other color information, thereby improving usability of light per electric input, and attaining entire brightness and reproducibility of color even at the same rated power.

In particular, the filter driving mechanism 210 sends, to the power supply controlling apparatus 30, information of the state where the filter 200 is positioned as shown in FIG. 2B, and the power supply controlling apparatus 30 stops light emission of the discharge lamp 10 or reduces current applied to the discharge lamp 10.

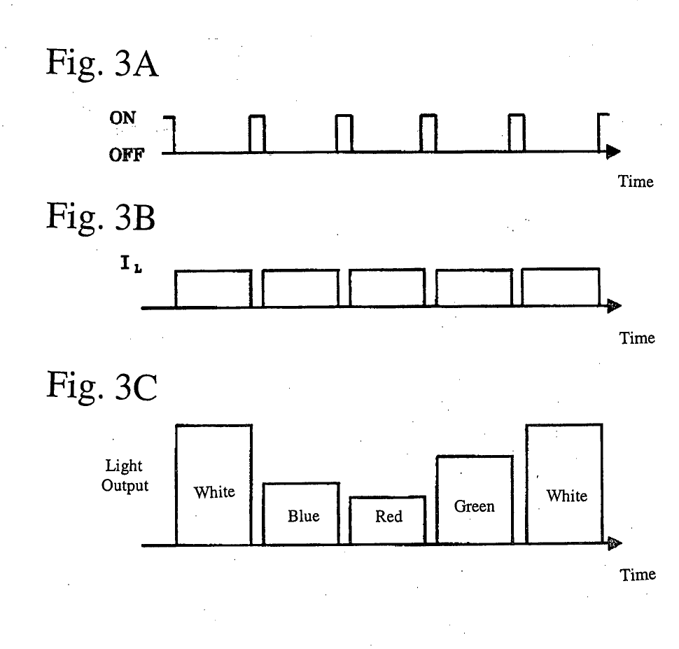

FIGS. 3A, 3B, and 3C are schematic charts showing relationship between current applied to the discharge lamp and light output projected.

FIG. 3A shows a signal which is sent to the power supply controlling apparatus 30 from the filter driving mechanism 210, wherein an on-signal is generated when a boundary of the filter is located above the light condensing area. In the figure, the vertical axis represents two states, that is, an ON state and an OFF state, and the horizontal axis represents time.

FIG. 3B is a chart of current value I_{L} flowing through the discharge lamp, wherein the vertical axis represents current value and the horizontal axis represents time. Although, to be exact, the current value is affected by overshoot or ripple at rising time, the effects are not shown as a matter of explanatory convenience in the figure.

FIG. 3C shows light output and color information projected on a screen, wherein the vertical axis represents light output and the horizontal axis shows time. As shown in the figure, it is found that power supply to the discharge lamp is stopped at the time when a boundary of color areas of the filter is located so as to correspond to the light condensing area.

Next, description of the discharge lamp will be given below.

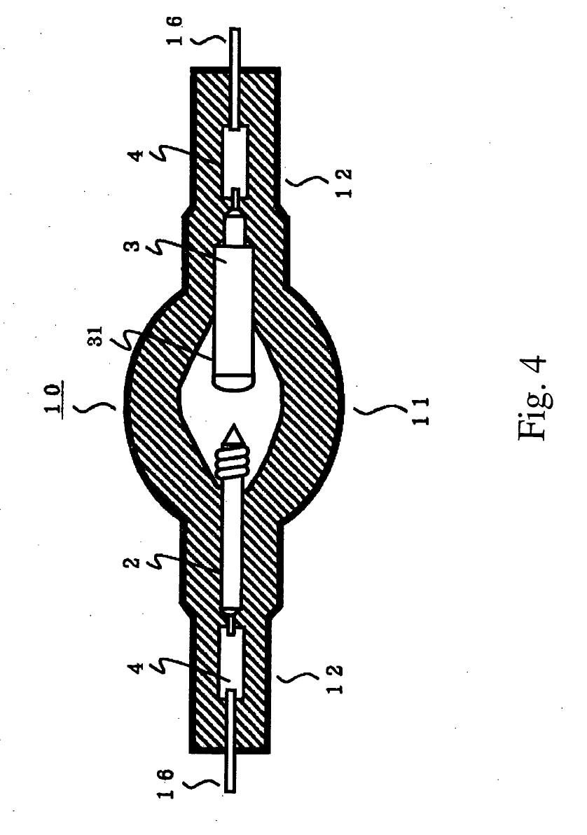

FIG. 4 is an over view of the high pressure discharge lamp which is used for a light source apparatus according to the present invention.

The discharge lamp 10 has an approximately spherical light emitting portion 11 formed as part of a discharge container made of quartz glass, wherein in the light emitting portion 11, an anode 2 and cathode 3 are disposed facing each other. A sealing portion 12 is formed so as to extend from each end portion of the light emitting portion 11, and in each sealing portion, a metallic foil for conduction 4 usually made of molybdenum is airtightly buried by, for example, shrink sealing. One end of each metallic foil 4 is connected to the anode 2 or the cathode 3, and the other end of the metallic foil 4 is connected to an external lead 16. A coil 31 is wound around the tip of the cathode 3. The coil 31 is made of tungsten and tightly wound around or welded to the cathode 3. While the coil 31 functions as a source of lighting initiation (starting position) according to a surface concavo-convex effect at the time of lighting initiation, it has a heat dissipation function according to the surface concavo-convex effect and the heat capacity after lighting.

In the light emitting portion 11, mercury, rare gas, and halogen gas are enclosed. The light emitting portion 11 is filled with 0.25 mg/mm³ or more of mercury in order to obtain radiation light of necessary visible light wavelength, for example, 400-700 nm wavelengths. Although the amount of the filling differs depending on the temperature condition, the vapor pressure is extremely high when it is 150 or more atmospheric pressure at time of lighting. Moreover, it is possible to make a high mercury vapor pressure discharge lamp whose mercury vapor pressure is 200 or more atmospheric pressure, or 300 or more atmospheric pressure at time of lighting by enclosing much more mercury, so that it is possible to realize a light source suitable for a projector apparatus, as the mercury vapor pressure becomes high. As for rare gas, for example, 13 kPa of argon gas is filled so that the lighting starting nature is improved. The halogen is enclosed in form of compound of iodine, bromine, chlorine etc. and other metals. The filled amount of halogen is selected from the range of, for example, 10⁻⁶ to 10⁻² μmol/mm³. Although the function of the halogen is to extend the life time of the discharge lamp by using the halogen cycle, in case of an extremely small discharge lamp with high inner pressure, as described above, there is an advantage that devitrification or destruction of the discharge container is prevented by enclosing halogen.

As a numerical example of such a discharge lamp, for example, the outer diameter of the light emitting portion is selected from the range of ψ6.0-15.0 mm, such as 9.5 mm, and the distance between the electrodes is selected from the range of 0.5-2.0 mm, such as 1.5 mm, and the arc tube internal volume is chosen from the range of 40-300 mm³, such as 75 mm³. As the lighting conditions, for example, the tube wall load is selected from the range of 0.8-2.0 W/mm², such as 1.5 W/mm², and rated voltage and rated-apparent-power are 80 V and 200 W, respectively. Moreover, this discharge lamp is built in a projector apparatus etc. to be miniaturized, and while the entire structure is miniaturized extremely, the high intensity light is required. Therefore, the thermal conditions of the inside of the light emitting portion become very severe. And the discharge lamp is disposed in an apparatus for presentations like a projector apparatus or an overhead projector, in which radiation light with good color rendering nature is provided.

The concave reflecting mirror 20 is an elliptic light condensing mirror having a short focal point, wherein a multi-layer film comprising titania, silica etc. is formed by vapor deposition on borosilicate glass or crystallization glass which is a base of the mirror. Further, a front glass 21 is disposed on a front opening of the concave reflecting mirror 20.

Next, description of a power supply controlling apparatus will be given below.

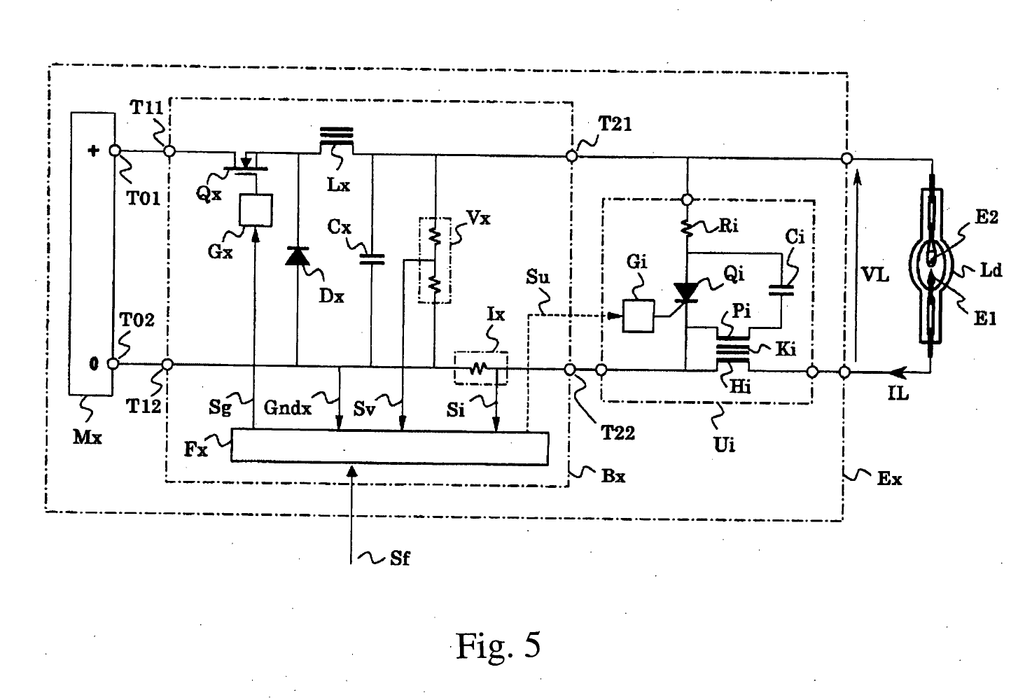

FIG. 5 shows the power supply feeding apparatus for lighting the discharge lamp 10.

In the power supply controlling apparatus (Ex), a step down chopper type ballast circuit (Bx) is operated by voltage from a DC power source (Mx) such as PFC etc. In the ballast circuit (Bx), current from the DC power source (Mx) is turned on and off by a switching device (Qx) such as FET etc. and a smoothing condenser (Cx) is charged through a choke coil (Lx). This voltage is impressed to the discharge lamp 10 and current flows in the discharge lamp 10.

High voltage pulses are generated on a secondary winding (Hi) by a starter (Ui) at time of lighting initiation. This high voltage is superimposed onto output voltage of the ballast circuit (Bx) and impressed between the electrodes 2 and 3, thereby starting discharge of the discharge lamp 10. A power supply controlling circuit (Fx) generates a gate driving signal (Sg), and the gate driving signal (Sg) is applied through a gate driving circuit (Gx) to a gate terminal of the switching device (Qx), thereby controlling current to be turned on/off by the DC power source (Mx). Discharge lamp current (IL) flowing through the discharge lamp 10 and lamp voltage (VL) generated between the electrodes 2 and 3 are detected by a current detector (Ix) and a voltage detector (Vx) respectively. Discharge lamp current signal (Si) from the current detector (1×) and discharge lamp voltage signal (Sv) from the voltage detector (Vx) are inputted in the power supply controlling circuit (Fx), and the duty cycle ratio of the gate driving signal (Sg) is controlled in a feedback manner, by comparing it with a desired value.

When a signal Sf for shutting off discharge lamp current from the filter driving mechanism 210 is inputted in the power supply controlling circuit (Fx), the power supply controlling circuit (Fx) transmits an off-gate driving signal (Sg) to the gate driving circuit (Gx), prioritizing it over the above-mentioned feedback control, thereby the switching device (Qx) is turned off, that is, power supply to the discharge lamp 10 is shut off.

In such a discharge lamp according to the present invention, in which the distance between electrodes is 2 mm or less, the amount of mercury is 0.15 mg/mm³ or more, the filled halogen amount is 10⁻⁶˜10⁻² μmol/mm³, it is preferred that power supply shutting off period is 4 milliseconds, preferably, 1 millisecond, and more preferably, 0.1 to 0.6 milliseconds. These conditions are obtained from various experiments, and when the power supply is shut off for more than 4 milliseconds, the discharge lamp itself is completely turned off, so that re-lighting is not possible without a starter. Furthermore, when the power supply shutting off period is 1 millisecond or more, it is possible to re-light the discharge lamp without initiating the starter. However, after supplying power, the arc becomes unstable, thereby causing notably unstable light output.

The above-mentioned result is explained below.

That is, in stationary lighting, the cathode is heated to a high temperature by current supplied from the outside, so that plasma is actively generated on the front face of the cathode by the thermionic emission from the cathode so that the stable arc discharge can be maintained. However, when the power supply is shut off, heat from the plasma which has heated the cathode is not applied to the cathode thereby causing temperature drop of the cathode. If it is a very short time, when current is supplied again, plasma can be generated by thermoelectron which is less than that at the time of the stationary lighting so that the lamp can be returned to the stationary lighting state in a short time by applying voltage higher than that at the time of the stationary lighting. However, since, when the shutting off time is longer, the density of electron in the discharge space declines, the discharge lamp cannot be returned to the stationary lighting state unless supply voltage is raised to a large extent, and as a result, the discharge lamp goes out.

Moreover, the current supplied to the discharge lamp is not necessarily shut off and the current may be reduced. Particularly, the current may be reduced to 90% or less of that at time of stationary lighting, preferably 50% or less. In this case, there is an advantage that the current tends to be stable when the current returns, as compared with the case of shutting off current. As an example, in order to reduce the current, when the power supply controlling circuit (Fx) of the power supply controlling apparatus 30 receives a signal Sf from the filter driving mechanism as the case where the current is shut off, it transmits a gate driving signal (Sg) so as to reduce the duty ratio to the switching device (Qx) (to make on period short).

In the present invention, the lamp current is not necessarily shut off or reduced on all the boundary of the color areas of the rotation filter. Although in the embodiment, the rotation filter 4 has 4 boundaries, the lamp current can be reduced or shut off on at least one boundary in order to obtain the effects of the present invention. Specifically, it is effective if the current is reduced or shut off on a boundary between colors other than white area.

The present invention can be applied to a case where such a rotation filter does not have a white area. That is, current applied to the discharge lamp is reduced or shut off on each boundary of a rotation filter having 3 color (RGB) areas. Since the boundary cannot be used for obtaining color information, when color reproducibility is important, the DMD element is moved in a dark side direction and held so that light is not projected. As described above, when light is not effectively used, the lamp output can be effectively used by reducing or shutting off current to the discharge lamp, while the rated power of the entire discharge lamp is not changed.

The discharge lamp according to the present invention is not limited to such a direct current lighting type discharge lamp shown in FIG. 4, and may be an alternate current lighting type discharge lamp.

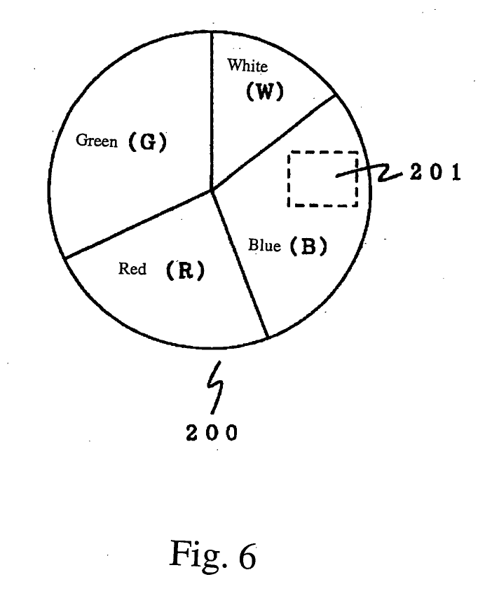

FIG. 6 is the structure of the rotation filter according to another embodiment of the present invention.

In the rotation filter shown in FIG. 6, an area of each color is determined, taking color balance or brightness at a time of projection on a screen into consideration. In particularly, center angles of the lemon wedge shape in the green (G), red (R), blue (B), and white (W) areas are 103 degrees, 77 degrees, 97 degrees, and 83 degrees, respectively. The light condensing area 201 which is virtually formed on the rotation filter is a 3.6×4.8 rectangular. While by using the rotation filter in the apparatus as shown in FIG. 1, the discharge lamp was turned on at rated current 3.1 A, and then shut off for 0.2 millisecond on each boundary of color areas.

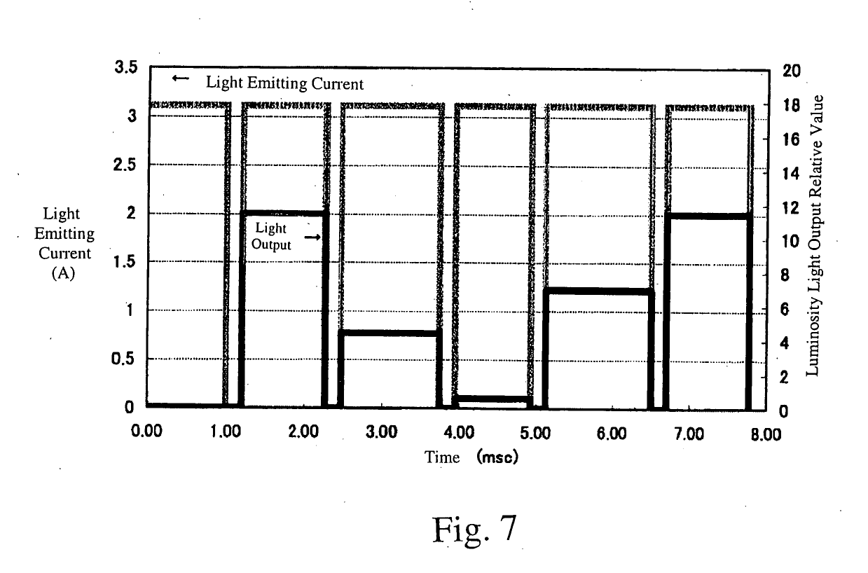

FIG. 7 shows relationship between light output and lamp current when the filter shown in FIG. 6 is used.

The lamp current was shut off in 1.0 millisecond after the lamp was turned on, and the lamp current (3.1 A) was applied to the discharge lamp in 0.2 millisecond after that. In this case, light output of white color was approximately 11.4 mV. In addition, the light output was shown as display value of a photocell Further, in 2.2 milliseconds after the lamp was turned on, the lamp current was shut off again, and then lamp current (3.1 A) was applied to the discharge lamp in 0.2 millisecond after that. In this case, light output of blue color was 4.4 mV.

Furthermore, in 3.7 milliseconds after the lamp was turned on, the lamp current was shut off again, and then lamp current (3.1 A) was applied to the discharge lamp in 0.2 millisecond after that. In that case, light output of blue color was 0.6 mV.

Moreover, the lamp current was shut off again in 4.9 millisecond after the lamp was turned on, and the lamp current (3.1 A) was applied to the discharge lamp in 0.2 millisecond after that. In this case, the light output of green was approximately 6.9 mV.

Further, lamp current was shut off again in 6.5 millisecond after the lamp was turned on, and the lamp current (3.1 A) was applied to the discharge lamp in 0.2 millisecond after that. In this case the light output of white was 11.4 mV.

Further, for comparison purposes, a filter in which color balance can be obtained with constant output without shutting off the lamp current is prepared, and light output thereof is measured. As a result, it is confirmed that in the light source apparatus according to the present invention, light output is improved over the compared apparatus, and further RGB color balance thereof is approximately the same as that of the compared apparatus.

Thus the present invention possesses a number of advantages or purposes, and there is no requirement that every claim directed to that invention be limited to encompass all of them.

The disclosure of Japanese Patent Application No. 2004-003765 filed on Jan. 9, 2004 including specification, drawings and claims is incorporated herein by reference in its entirety.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

1. A light source apparatus for a projector having a rotation filter in which at least RGB color areas are formed, a rod integrator lens to which light passing through a light condensing area on the rotation filter is incident, and an image display device receiving light emitted from the rod integrator lens, the light source comprising:
a high pressure discharge lamp containing 0.16 mg/mm³ mercury;
a power supply controlling apparatus for the high pressure discharge lamp;
wherein the power supply controlling apparatus shuts off or reduces current to the discharge lamp when a boundary between a first color area and a second color area is located at a position corresponding to the light condensing area.

2. The light source apparatus according to claim 1, wherein time for shutting off or reducing current applied to the discharge lamp is 4 milliseconds or less.

3. The light source apparatus according to claim 1, wherein 0.16 mg/mm³ of mercury is filled in the discharge lamp.

4. A light source apparatus comprising:
a rotation filter having a light condensing area, in which at least a first color area and a second color area are formed;
a lens to which light passing through the light condensing area is incident;
an image display device receiving light emitted from the rod integrator lens;
a discharge lamp; and
a power supply controlling apparatus which controls power supply to the discharge lamp,
wherein the power supply controlling apparatus shuts off or reduces current applied to the discharge lamp when a boundary between the first color area and the second color area is located at a position corresponding to the light condensing area.

5. The light source apparatus according to claim 4, wherein the rotation filter has the first color area, the second color area and a third color area.

6. The light source apparatus according to claim 5, wherein the rotation filter has the first color area, the second color area, a third color area, and a forth color area.

7. The light source apparatus according to claim 4, wherein the forth color area is a white area.

8. The light source apparatus according to claim 7, wherein the first color area is a green area, the second color area is a red area, and the third color area is a blue area.

9. The light source apparatus according to claim 8, wherein the green, red, blue and white areas have a lemon wedge, respectively.

10. The light source apparatus according to claim 9, wherein the green area has a 103 degree center angle, the red area has a 77 degree center angle, the blue area has a 97 degree center angle and the white area has a 83 degree angle.

11. The light source apparatus according to claim 4, wherein the light condensing area has a rectangular shape.

12. The light source apparatus according to claim 4, wherein the lens is a rod integrator lens.

13. The light source apparatus according to claim 4, wherein the image display device is a digital micromirror device.

14. The light source apparatus according to claim 4, wherein the discharge lamp is a high pressure mercury lamp.

15. The light source apparatus according to claim 3, further including a filter driving mechanism which sends a signal to the power supply controlling apparatus when a boundary between the first color area and the second color area is located at a position corresponding to the light condensing area, wherein the power controlling apparatus shuts off or reduces the current to the discharge lamp based on the signal.
